(19) United States
(12) Patent Application Publication
(10) Pub. No.: US 2007/0065557 A1
(43) Pub. Date: Mar. 22, 2007

(54) Non sweet binder for savory food product

(76) Inventors: Pramod Kumar Pandey, Irwindale, CA (US); Julia Maria Guerrero, Lachine (CA); Margaret Ciaston, Irwindale, CA (US)

Correspondence Address: Ralph A. Dowell of DOWELL & DOWELL P.C., 2111 Eisenhower Ave, Suite 406, Alexandria, VA, 22314, US

(21) Appl. No.: 11/522,979

(22) Filed: Sep. 19, 2006

Related U.S. Application Data
(60) Provisional application No. 60/717,760, filed on Sep. 19, 2005.

(51) Int. Cl. A23L 1/09

(52) U.S. Cl. 426/572

(57) ABSTRACT

The present invention relates to non sweet food binder composition. Particularly, the food binder composition can be used in the preparation of savory snack bars, savory nutritional bars, or in savory food products used as snack or meal replacement, containing varied levels of protein, fiber, minerals, vitamins and other bioactive substances or nutritional supplements.

### CROSS-REFERENCE TO RELATED APPLICATIONS

This application claims priority on U.S. provisional application No. 60/717,760 filed Sep. 19, 2005 which is enclosed herewith in its entirety.

### FIELD OF THE INVENTION

The present invention relates to a non sweet binder composition for savory food product, method of preparation and uses of the binder. The present invention also relates to a non sweet binder that can be used in the manufacture of savory nutritional bar and methods of producing such savory nutritional bars.

### BACKGROUND OF THE INVENTION

Food binder is generally a complicated mixture of carbohydrate protein, oil and fat, water and air, as well as a variety of other minute components such as minerals, vitamins and flavors. The food binder is usually submitted to a wide range of thermal treatments (such as baking, boiling, steaming and/or freezing) and mechanical treatments (such as kneading, mixing, extruding, etc.) all of which further complicate the structure of the food. The desired result of these treatments is good tasting food. For this reason, products with improved flavor, texture and quality are always in demand.

A variety of methods and products have been used as food binders to bind food materials in order to shape the final food product. Confectionery and baking industries use food binders in variety of ways, however, most of them are sweet in taste (e.g. sugar-based) which limits their application to sweet confections. The ability of these binders to modify the textural characteristics of the finished confections (such as granola or crisp based product) depends on their solid content and their sugar type. A very important characteristic of food binders is their moisture content or total solid content. Food binders should preferably have a low moisture content and a high solubilized solid content (76-85% soluble solid) to be able to disperse properly while mixing with food products. Binders having low solid content or a high moisture content are usually of poor quality with unacceptable texture and a very limited shelf-life (high moisture binder allows microbial spoilage).

In order to obtain a non sweet savory binder, it has been suggested a method in which food materials are bound by using a combination of the enzyme transglutaminase and caseins (or their derivatives). However, the use of this binder in crispy nutritional savory is impossible because its soluble solid content is not high enough to make it flowable. In addition, because of the presence of very large amount of moisture available for migration, the food product having this binder has a very short shelf-life and undesirable texture.

U.S. Pat. No. 4,247,573 (issued on Jan. 27, 1981) discloses a food composition which can include an egg white (partially replaced by or added to one protein micellar mass) as a food binder. However, this binder has no practical application in the development of crispy/crunchy food product due to its high moisture content which makes the final product soggy. The final product has also a very limited shelf-life.

U.S. Pat. No. 4,650,685 (issued on Mar. 17, 1987) discloses a biscuit comprising a binder. The binder comprises from 8 to 30 parts by weight of sucrose and/or mixtures of glucose and its polymers. This binder has a sweet taste due to its sucrose content. This binder is also used in the manufacture of baked goods therefore it possesses a low moisture content.

U.S. Pat. No. 5,514,408 (issued on May 7, 1996) discloses a food binder composition for binding food without heating, which comprises at least one protein which is soluble or dispersible in a neutral or alkaline aqueous solution, and which is selected from the group consisting of ovalbumin, wheat, whey, sodium caseinate, plasma protein and mixtures thereof; and at least one powdery product selected from the group consisting of a hydroxide of an alkaline earth metal, an oxide of an alkaline earth metal, calcined eggshell, burned eggshell, calcined shell of a land or sea animal, burned shell of a land or sea animal, calcined bone, burned bone, and mixtures thereof; the composition capable of binding food without heating and containing from 2 to 100 parts of said powdery product per 100 parts of the protein. This binder is intended to be used in meat, fish or seafood-based products such as ham, Chinese sausage, fishball, meatball, etc. This type of binder is not suitable for confectionery savory application due to its high moisture content and undesirable Theological properties.

U.S. Pat. No. 4,910,031 (issued on Mar. 20, 1990) discloses a binder comprising sugar and a sweetness suppressor as well as its use in savory snack food production. The binder preferably exhibits a water activity of about 0.65 to 0.9. This binder has a very high sugar content and a very high water activity which favors spoilage of the binder or the finished product. This binder is mainly used to adhere the seasoning topping.

U.S. patent application Ser. No. 10/973,626 (filed on Oct. 10, 2004, published under 2006/0088628 on Apr. 27, 2006) discloses food bar comprising a binder. The binder preferably has at least 40% solids, a fibrous ingredient as well as glycerol and/or a fatty acid. The binder may also contain various fibrous ingredients. The fibrous ingredient used in this application is dextrin, preferably from a wheat source (e.g. resistant starch labeled as fiber). A wetting agent very similar to this binder has also been described in U.S. patent application Ser. No. 11/017,127 (filed on Dec. 20, 2004, published under 2006/0134312 on Jun. 22, 2006).

U.S. patent application Ser. No. 10/326,103 (filed on Dec. 23, 2002, published under 2003/0087004 on May 8, 2003) discloses food bars having less than 10% per weight of sugar or sugar-substitutes. A solid flavored composition can also be added to the food bars which augments consumer acceptance.

Despite these existing binders described above, none of them can satisfactorily be used to make adequate binder for savory application (especially in crispy/crunchy food products), there still remains a need for development in the area of food binders for savory application.

### SUMMARY OF THE INVENTION

The present application relates to a savory food binder composition that can be advantageously used in the production of savory foods.

According to one aspect, the present invention provides a savory food binder composition comprising: (i) between about 10 to 25% by weight of moisture content, (ii) less to about 10% by weight of a fat, (iii) between about 5 to about 50% by weight of a food hydrocolloid, and (iv) between about 10 to about 80% by weight of a non-hydrocolloid carbohydrate. In an embodiment, the fat is in a form selected from the group consisting of an oil, a shortening, a saturated fat and an unsaturated fat. In another embodiment, the hydrocolloid is selected from the group consisting of Arabic gum, agar agar, calcium carboxymethylcellulose, carrageenan, guar gum, ghatti gum, tragacanth gum, henna powder, locust bean gum, menthol crystal, propylene glycol alginate, psyllium, sodium alginate, sodium carboxymethylcellulose, tara gum, xanthan gum, pectin and vanilla bean. In yet a further embodiment, the hydrocolloid is Arabic gum. In yet another embodiment, the non-hydrocolloid carbohydrate is selected from the group consisting of a monosaccharide (such as glucose, fructose and/or galactose), a disaccharide (such as sucrose, lactose and/or maltose), a sugar alcohol (such as sorbitol, mannitol, xylitol, erythritol, maltitol, lactitol and/or glycerol), an oligosaccharide (such as raffinose, stachyose, verbascose and/or fructooligosaccharide) and a polysaccharide (such as starch, inulin and/or polydextrose). In yet. another embodiment, the non-hydrocolloid carbohydrate is under form of a syrup or a solid. In still another embodiment, the binder composition further comprises less then about 30% by weight of glycerin. In still a further embodiment, the binder composition further comprises less than about 5% by weight of an emulsifier. In yet a further embodiment, the binder composition has between about 75% and about 90% of total solids, and still in yet a further embodiment, between about 80% and 90% of total solids. In still another embodiment, the binder composition further comprises a sweetness suppressant.

According to another aspect, the present invention provides a food composition comprising the savory food binder composition described herein. In an embodiment, the food composition is a savory food. In another embodiment, the food composition is a Granola-type bar comprising between about 5 to about 50% by weight of a protein, and in yet a further embodiment, the Granola-type bar comprises fortification. In still another embodiment, the food composition is a crispy-type bar comprising between about 5 to about 50% by weight of a protein. In yet a further embodiment, the food composition is a low glycemic index savory bar. In still another embodiment, the food composition has a shape selected from the group consisting of a bar, a ball, a bite size, a square and an irregular shape.

According to a further aspect, the present invention provides a method of aggregating food components, said method comprising combining the savory food binder composition described herein with food components thereby aggregating the food components. In an embodiment, the savory food binder is heated prior to its combination with the food components.

### DETAILED DESCRIPTION OF THE PREFERRED EMBODIMENTS

The present invention now will be described more fully hereinafter, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all terms of art, notations and other scientific terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. The techniques and procedures described or referenced herein are generally well understood and commonly employed using conventional methodology by those skilled in the art, such as, for example, the widely utilized in food industries.

In accordance with the present invention, there is provided a new food binder which allows the binding of food components with different tastes. Since this new food binder is not sweet, it can be advantageously used in the production of savory foods.

As used herein, the term “binder” is intended to mean a substance that produces or promotes cohesion in loosely assembled ingredients. Because the binder described herein is intended to be used in the production of food, it is preferably a food-grade binder. In an embodiment, the binder composition described herein is a savory binder and does not have a sweet taste. In a further embodiment, the binder composition is a flowable binder. As used herein, the term “flowable” of “flows” refers to the consistency of a solution. It is generally measured by evaluating the resistance to flow of the solution under specific conditions for a specific period of time. A solution is “flowable” or “flows” if it shows a reading of more than 1 cm, at 40° C. in 30 seconds on a consistometer (such as a Bostwick consistometer).

According to one embodiment, the binder composition comprises between about 10 to about 20% of moisture content. This low moisture content enables the finished food product to have a longer shelf life and does not substantially alters the crispiness of the finished product. As used herein, the term “moisture content” refers to the percentage content of foods known to those skilled in the art. Such methods include, but are not limited to, evaporation methods, distillation methods, chemical reaction methods (such as the Karl-Fisher titration and the gas production method), physical methods and spectrometric methods (such as X-rays, UV-visible, NMR, microwaves and IR). The moisture content of the binder can be also calculated during formulation by knowing and adding the moisture content of each ingredient.

In an embodiment, water can be used in the production of the binder. The person skilled in the art will recognize that the water can be replaced by any food-grade aqueous solutions such as, but not limited to, juice or stock.

According to another embodiment, the binder composition comprises less then about 10% by weight of fat. However, the total fat content of the finished product comprising the binder may be higher than 10%. In one embodiment, the fat present in the binder composition is in the form of an oil, a shortening, or a grease. The fat that can be used in the production of the binder may also be in liquid form, in solid form and/or in semi-solid form. The fat can be from animal, plant or synthetic origin. Preferably, the fat is emulsified prior to its incorporation to the binder. Examples of fat that can be used in the binder are fractionated fat, partially fractionated fat, hydrogenated oil, partially hydrogenated oil, unsaturated oil, coconut oil, palm oil, palm kernel oil, cottonseed oil, safflower oil, sunflower oil, soy oil, corn oil, monoglyceride and/or lecithin. The fat used is preferably a saturated fat such as a fractionated palm kern oil, a fractionated palm oil and/or a coconut oil.

In a further embodiment, the binder composition comprising between about 5 to 50% by weight of a food hydrocolloid. As used herein, the term “hydrocolloid” is intended to mean an hydrophilic polymer containing many hydroxyl groups and being a polyelectrolytes. The hydrocolloid can be of vegetable, animal, microbial or synthetic origin. The hydrocolloid can modify various physico-chemical properties of finished products such as the viscosity (including thickening and gelling), water binding, emulsion stabilization, prevention of ice recrystallization and organoleptic properties. The degree with which the hydrocolloid solutions mix with saliva, determined by their degree of chain entanglement, determines flavor perception of the binder. The food hydrocolloid that can be advantageously used in the binder is an hydrocolloid having a high water solubility. Any hydrocolloid that flows up to a 5% concentration and does not form a gel can be used in the savory binder. Among hydrocolloids that can be used in the preparation of the food binder, there is the arabic gum, agar agar, calcium carboxymethylcellulose, carrageenan, guar gum, ghatti gum, tragacanth gum, henna powder, locust bean gum, menthol crystals, propylene glycol alginate, psyllium, sodium alginate, sodium carboxymethylcellulose, tara gum, xanthan gum, pectins and/or vanilla beans. The hydrocolloid can be a single hydrocolloid or a mixture thereof Arabic gum is a preferred hydrocolloid because of its very high water solubility, a 50% solution of Arabic gum can easily be obtained. The hydrocolloid content of a composition can be easily calculated by those skilled in the art during formulation.

In another embodiment, the binder comprises between about 10 to 80% by weight of a non-hydrocolloid carbohydrate. As used herein, the term “non-hydrocolloid carbohydrate” refers to carbohydrates other than the hydrocolloids described above. The carbohydrate can be selected from the group consisting of a monosaccharide (such as glucose, fructose and/or galactose), a disaccharide (such as sucrose, lactose and/or maltose), a sugar alcohol (such as sorbitol, mannitol, xylitol, erythritol, maltitol, lactitol and glycerol), an oligosaccharide (such as raffinose, stachyose, verbascose and/or fructooligosaccharide) and a polysaccharide (such as starch, inulin and/or polydextrose). Because the binder can be used in the production of savory food products, the presence of the carbohydrate in the binder preferably does not give a sweet taste to the binder. In an embodiment, the carbohydrate can augment the solid content level of the binder. The carbohydrate can be, for example, a low dextrose equivalent (DE) corn syrup, a maltitol syrup, sorbitol syrup, high HP2 hydrogenated starch hydrolysate, fructo-oligosaccharides, oligofructose, inuline and/or derivatives of these carbohydrates. The carbohydrate used in the binder may be in a solid or a liquid form. Optionally, the carbohydrate may be in the form of a syrup or a solid.

In a further embodiment, the binder may also comprise less than 30% by weight of glycerin. Glycerin may, for example, be used as an humectant and/or a plasticizer in the savory binder composition.

In still another embodiment, the binder may also comprise less than 5% by weight of an emulsifier. As used herein, an emulsifier is intended to mean a surface-active agent promoting the formation and stabilization of the emulsion. Such emulsifiers include, but are not limited to, mono- and diglyceride glyceryl monostearate, mono- and diglyceride, distilled monoglyceride, distilled acetylated monoglyceride, distilled propylene glycol ester of fatty acid, polyglycerol ester of fatty acid, sorbitan fatty acid ester, lecithin, succinylated monoglyceride, acetic acid esters of monoglycerides, lactic acid esters of monoglycerides, citric acid esters of monoglycerides, succinic acid esters of monoglycerides, diacetyl tartaric acid esters of monoglycerides, sucrose esters of fatty acids, calcium stearoyl di laciate, and enzyme digested lecithin. The addition of an emulsifier can facilitate the processing of the binder and food products containing the binder by helping handling and shaping the food compositions.

In a further embodiment, the total solid content of the binder composition is between about 75% and about 90%, preferably between about 80% and about 90%. As used herein, the term “total solid content” refers to the sum of dissolved and suspended solid constituents in water. Its percentage can be easily calculated by substracting the moisture content of the composition from the value 100. The total solid content can be easily determined by those skilled in the art. In order to determine the total solid content of a binder composition, one must first determine the moisture content of the composition (refer to the methods described above) and then deduce the moisture content from the value 100. The total solid content of the binder composition can also be calculated during formulation by knowing the initial amount of solid ingredients and by determining the moisture loss during the processing of the product.

The binder composition may also comprise a sweetness suppressor. Such sweetness suppressors are especially useful when the binder composition has a sweet taste and is intended to be used in the manufacture of savory food products.

The binder composition may further comprise salts, such as but not limited to, parts of additional calcium, preferably in the form of calcium carbonate, in addition to the calcium already present in other products, such as non-fat milk solids. The binder may further comprise added vitamins, oligo-elements, and sodium chloride.

The binder composition described herein can be used with various food products, such as nutritional bars. The binder composition described herein can be advantageously used to bind protein nuggets in savory nutritional bars. The binder described herein can be incorporated in any food production to allow the cohesion of the ingredients and facilitate the shaping of the final food product. In addition, because the binder presented herein does not have a sweet taste, it can be advantageously used in the preparation of a savory food (such as savory snack food), crispy crunchy food and/or a salty food (such as a salty snack food). The binder can be added to a variety of foods such as nutritional bars, cheese and dairy products, cheese substitute, fruit and vegetable pieces, cinnamon, pieces of nuts, sesame seeds, pieces of ham, pieces of bacon, dried meat product or meat imitations, cheese and dairy pieces, fruit pieces, cinnamon, and mixtures thereof. When the binder is added to nutritional bars, it is useful in binding the ingredients of the bars (such as nuts, cereals, crisps and nuggets, grains, proteinaceous substances, dried vegetable pieces and or powder).

The materials that can be used as components of the binder of the present invention are naturally available or anything edible. Of course, as will be appreciated by those skilled in the art, the particular method of application employed will depend in part on the type of material which comprises the first edible food material.

The binder presented herein has little or no effect on the taste or flavor of the final food product and will not introduce undesirable tastes or flavor.

Prepared foods, after addition of the binder of the present invention, will not be disintegrated upon refrigeration or thawing, so that the binding of foods is maintained.

Although savory nutritional bars are preferably targeted for the use of the binder of the present invention, any other shape such as ball, or bite size chew or trial type food product which is normally made with the incorporation of a food binder, can be considered among the different embodiments or variants of the present invention. Of course, the concentration of the food binder can be adapted depending of its use or the product in which it is incorporated.

In another embodiment, the present application provides a method of using the binder composition described herein. The binder can be produced and stored until required to use. Alternatively, the binder composition can be made in a continuous fashion and added directly to the savory product.

In order to add the binder composition to the savory food product, the binder composition can be first heated (e.g. around 60-90° C.) in heating kettle in order to make the binder flow. Dry ingredients (powdered, crisp, particulate, nuts, cereals, grains, dried vegetable, dried fruit pieces, flavoring compound) are then added to the liquid savory binder to form particulates. This last step is usually performed with a single or double arm sigma type or continuous mixer (Gericke type). Optionally, fat or oil can be added to the mixture to coat the particulates obtained in order to make their surface inert and non-absorbing, to lengthen the shelf-life and heighten the crispiness of the product. The dry indigents, flavoring/coloring compounds and mineral and vitamins can also be added together or independently depending on the known art, type of equipment used to manufacture. A gentle mixing of dry ingredients with the binder preserve the integrity of the finished product.

The first heating step is usually performed between 60-90° C. depending on the nature of the dry ingredients to be added and the ambient viscosity of the binder. For example, the higher the viscosity of the binder, the higher the temperature of the first heating step.

The present invention will be more readily understood by referring to the following examples which are given to illustrate the invention rather than to limit its scope.

### EXAMPLE I

### Binder with Arabic Gum and Maltitol Syrup

TABLE 1
Quantity (in percentage of final weight) of the ingredients
used in the preparation of the savory binder.

| Ingredients | Percentage |
|---|---|
| Glycerin | 20.06 |
| Water | 20.4 |
| Arabic gum | 28.14 |
| LYCASIN ™ (maltitol syrup) 80% solid | 26.04 |
| Fractionated palm kern oil | 2.34 |
| Lecithin | 0.47 |
| Monoglycerides Distilled | 0.24 |
| Tocopherols, Mixed | 0.047 |
| Salt Regal Fine Prepared | 2.27 |

The glycerin and water are added to a cooker and mixed. The Arabic gum is added to the cooker and mixed. The maltitol syrup is then added to the cooker and mixed. This first mixture is cooked at 225° F. under continuous stirring. When the cooked mixture reaches brix 78, the palm kern oil, the lecithin and the monoglycerides are added to the mixture under continuous stirring. When the cooked mixture reaches brix 80, the salt is added to the mixture under continuous stirring. The mixture is cooked by increasing its temperature and mixed until it reaches a temperature of 240° F. and a brix 84. The total solid content of the binder composition is 88%. The binder as prepared herein, can be used to make crispy nutritional bars by binding proteinaceous material (powder and nuggets-like soy/rice, nuts), carbohydrate (dried vegetable pieces), and fat. The nutritional bar can be optionally coated and can be produced as one layer or multiple layers with or without proteinaceous material. The nutritional bars can optionally be fortified with minerals and vitamins.

### EXAMPLE II

### Binder with Arabic Gum and Liquid Corn Syrup

TABLE 2
Quantity (in percentage of final weight) of the
ingredients used in the preparation of the binder.

| Ingredients | Percentage |
|---|---|
| Arabic gum | 10 |
| Water | 16 |
| Glycerin | 15 |
| Corn syrup (28DE) | 53.32 |
| Fractionated palm kern oil | 2.61 |
| Lecithin | 0.52 |
| Monoglycerides Distilled | 0.26 |
| Tocopherols, Mixed | 0.057 |
| Salt Regal Fine Prepared | 2.23 |
| Super Envision | 0.12 |

The binder composition is mixed and processed similarly as the one described in Example 1. More specifically, the Arabic gum and water are placed in a mixer and mixed very well. The glycerin and corn syrup are added to the mixture. The mixture is cooked at 220° F. under high shearing. When the mixture reaches brix 75, the palm kern oil, the lecithin, the monoglycerides and the tocopherols are then added under continuous stirring. When the fat has integrated the mixture, the salt and the super envision are added. The mixture is cooked and mixed until it reaches a temperature of 231° F. and a brix 82. The total solid content for this binder composition is 85%.

### EXAMPLE III

### Binder with Senegal Arabic Gum and Corn Syrup

TABLE 3
Quantity (in percentage of final weight) of the
ingredients used in the preparation of the binder.

| Ingredients | Percentage |
|---|---|
| Senegal Arabic gum | 11.14 |
| Corn syrup (A) (28DE) | 11.14 |
| Water | 17.2 |
| Glycerin | 16.7 |
| Corn Syrup (B) (28DE) | 38.04 |
| Fractionated palm kern oil | 2.61 |
| Lecithin | 0.52 |
| Monoglycerides Distilled | 0.26 |
| Tocopherols, Mixed | 0.057 |
| Salt Regal Fine Prepared | 2.23 |
| Super Envision | 0.12 |

The binder composition is mixed and processed similarly as the one described in Example 1. More specifically, the Arabic gum and the corn syrup (A) are placed in a mixer and mixed very well. The water is added and the mixture is mixed until the Arabic gum is well hydrated. Then, the glycerin is added and mixed well. The corn syrup (B) is then added. The mixture is then cooked at 230° F. under high shearing. When the mixture reaches 162° F. and a brix of 80, the palm kern oil, lecithin, monoglycerides and tocopherols are added. When the fats have integrated the mixture, the salt and the super envision are added. The mixture is cooked and mixed until it reaches a temperature of 221° F. and a brix of 82. The total solid content for this binder composition is 86%.

### EXAMPLE IV

### Binder with a High Level of Glycerin and Arabic Gum

TABLE 4
Quantity (in percentage of final weight) of the
ingredients used in the preparation of the binder.

| Ingredients | Percentage |
|---|---|
| Arabic gum | 10 |
| Water | 16 |
| Glycerin | 21 |
| Corn Syrup (28DE) | 47.32 |
| Fractionated palm kern oil | 2.61 |
| Lecithin | 0.52 |
| Monoglycerides Distilled | 0.26 |
| Tocopherols, Mixed | 0.057 |
| Salt Regal Fine Prepared | 2.23 |
| Super Envision | 0.12 |

The binder composition is mixed and processed similarly as the one described in Example 1. More specifically, the Arabic gum and the water are placed in a mixer and mixed very well. Then, the glycerin and the corn syrup are added. The mixture is cooked at 230° F. under high shearing. When the mixture reaches 200° F. and a brix of 75, the palm kern oil, the lecithin, the monoglycerides and the tocopherols are added. The mixture is stirred until the fats have been integrated. Then, the salt and the super envision are added. The mixture is mixed until it reaches a temperature of 231° F. and a brix of 82. The total solid content for this binder composition is 86%.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

We claim:

1. A savory food binder composition comprising:
between about 10 to about 25% by weight of moisture content,
less to about 10% by weight of a fat,
between about 5 to about 50% by weight of a food hydrocolloid, and
between about 10 to about 80% by weight of a non-hydrocolloid carbohydrate.

2. The savory food binder composition of claim 1, wherein said fat is in a form selected from the group consisting of an oil, a shortening, a saturated fat and an unsaturated fat.

3. The savory food binder composition of claim 1, wherein said hydrocolloid is selected from the group consisting of Arabic gum, agar agar, calcium carboxymethylcellulose, carrageenan, guar gum, ghatti gum, tragacanth gum, henna powder, locust bean gum, menthol crystal, propylene glycol alginate, psyllium, sodium alginate, sodium carboxymethylcellulose, tara gum, xanthan gum, pectin and vanilla bean.

4. The savory food binder composition of claim 1, wherein said hydrocolloid is Arabic gum.

5. The savory food binder composition of claim 1, wherein said non-hydrocolloid carbohydrate is selected from the group consisting of a monosaccharide, a disaccharide, a sugar alcohol, an oligosaccharide and a polysaccharide.

6. The savory food binder composition of claim 5, wherein said monosaccharide is selected from the group consisting of glucose, fructose and galactose.

7. The savory food binder composition of claim 5, wherein said disaccharide is selected from the group consisting of sucrose, lactose and maltose.

8. The savory food binder composition of claim 5, wherein said sugar alcohol is selected from the group consisting of sorbitol, mannitol, xylitol, erythritol, maltitol, lactitol and glycerol.

9. The savory food binder composition of claim 5, wherein said oligosaccharide is selected from the group consisting of raffinose, stachyose, verbascose and fructooligosaccharide.

10. The savory food binder composition of claim 5, wherein said polysaccharide is selected from the group consisting of starch, inulin and polydextrose.

11. The savory food binder composition of claim 5, wherein said non-hydrocolloid carbohydrate is under form of a syrup or a solid.

12. The savory food binder composition of claim 1, further comprising less then about 30% by weight of glycerin.

13. The savory food binder composition of claim 1, further comprising less than about 5% by weight of an emulsifier.

14. The savory food binder composition of claim 1, having between about 75% and about 90% of total solids.

15. The savory food binder composition of claim 1, having between about 80% and 90% of total solids.

16. The savory food binder composition of claim 1, further comprising a sweetness suppressant.

17. A food composition comprising the savory food binder composition of claim 1.

18. The food composition of claim 17 being a savory food.

19. The food composition of claim 17 being a Granola-type bar comprising between about 5 to about 50% by weight of a protein.

20. The food composition of claim 19, wherein said Granola-type bar comprises fortification.

21. The food composition of claim 17 being a crispy-type bar comprising between about 5 to about 50% by weight of a protein.

22. The food composition of claim 17 being a low glycemic index savory bar.

23. The food composition of claim 17, wherein said food composition has a shape selected from the group consisting of a bar, a ball, a bite size, a square and an irregular shape.

24. A method of aggregating food components, said method comprising combining the savory food binder composition of claim 1 with food components thereby aggregating the food components.

25. The method of claim 24, wherein said savory food binder is heated prior to its combination with the food components.
